(19) United States
(12) Patent Application Publication
(10) Pub. No.: US 2007/0138818 A1
(43) Pub. Date: Jun. 21, 2007

(54) Inflatable cushion structure

(76) Inventor: Ching-Hua Chong, Yung He City (TW)

Correspondence Address: TROXELL LAW OFFICE PLLC;SUITE1404, 5205 LEESBURG PIKE, FALLS CHURCH, VA, 22041, US

(21) Appl. No.: 11/304,738

(22) Filed: Dec. 16, 2005

(51) Int. Cl. B60J 9/00

(52) U.S. Cl. 296/1.01

(57) ABSTRACT

An inflatable cushion structure comprises a cushion body that is provided with an air passage for air to inflate or deflate said cushion body. The improvement characterized in that indents are provided inwardly two lateral sides of said cushion body, while a plurality of holes for binding by ropes are provided along the periphery of said cushion body, such that, after placing said cushion body under a car and inflating said cushion body, the inflated cushion body can lift the car upwardly and apart from the ground, while wheels of the car can be accommodated just in said indents, respectively, and ropes can penetrate through said plurality of holes on the surface of the cushion body and securely bind said cushion body with the chassis of the car.

### BACKGROUND OF THE INVENTION

1. Field of the Invention

The invention relates to an inflatable cushion structure, and in particular, to an inflatable cushion structure characterized in that it can be placed beneath a car, and after being inflated, it can lift the car upward and away from the ground. This inflatable cushion has a simple structure, can be used conveniently, and is suitably applicable for all kind of cars before water flood.

2. Description of the Prior Art

Nowadays, weather is treacherously changeable. Particularly in the summer time, typhoon or an afternoon thundershower may frequently bring an unexpected amount of rain. In every unexpected downpour, floods will take place readily in low-lying or poor drainage regions wherein in addition to direct lose of properties in terms of damages on houses, car immersing in water becomes always a problem as well.

Therefore, if being acknowledged of the coming of a heavy rainfall from weather forecast, the car owners need to remove their cars from low-lying or poor drainage regions to an altitude, and afterwards return the cars back. This is a very troublesome matter. Accordingly, before the water drainage problem being addressed, the invention may provide a structure to be employed as a precaution beforehand for preventing a car from immersing in water.

### SUMMARY OF THE INVENTION

The main objective of the invention is to provide an inflatable cushion structure characterized in that it has a simple structure, can be used conveniently, and after inflation, it can lift a car upwardly and away from the ground.

In order to achieve the above-mentioned objective, an inflatable cushion structure provided by the invention comprises a cushion body, provided with an air passage for air to inflate or deflate the cushion body. The improvement consists of: each of two sides of said cushion body being provided inwardly with two lateral indents, and a plurality of holes being provided along the periphery of said cushion body for binding with ropes. When said cushion body is placed beneath a car and is inflated, the inflated cushion body can lift the car upwardly to apart from the ground, during which wheels of the car can be accommodated in each of the lateral indents, respectively, and while through said plurality of holes, ropes can securely bind said cushion body with the chassis of the car.

### BRIEF DESCRIPTION OF THE DRAWINGS

These features and advantages of the present invention will be fully understood and appreciated from the following detailed description of the accompanying Drawings.

FIG. 1 is a three-dimensional external view of an embodiment according to the invention.

FIG. 2 is an upward view of an embodiment according to the invention.

FIG. 3 is a schematic view showing the status of use after combining the embodiment according to the invention with a car.

### DETAILED DESCRIPTION OF THE PREFERRED EMBODIMENT

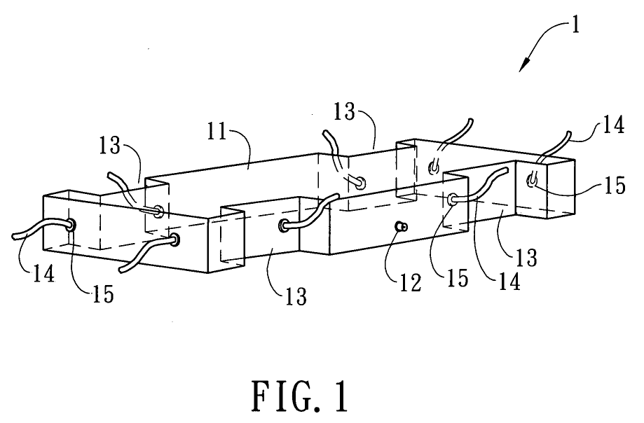

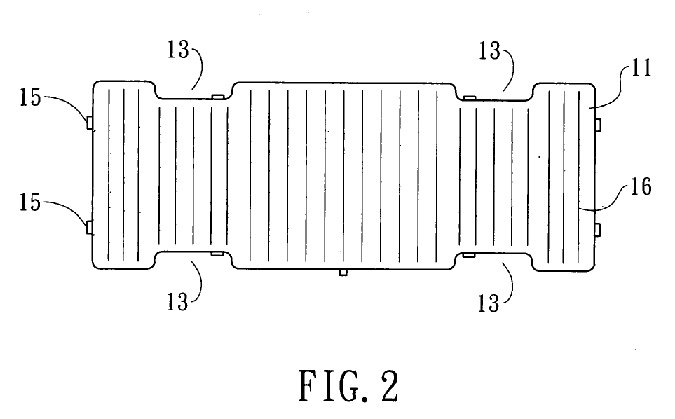

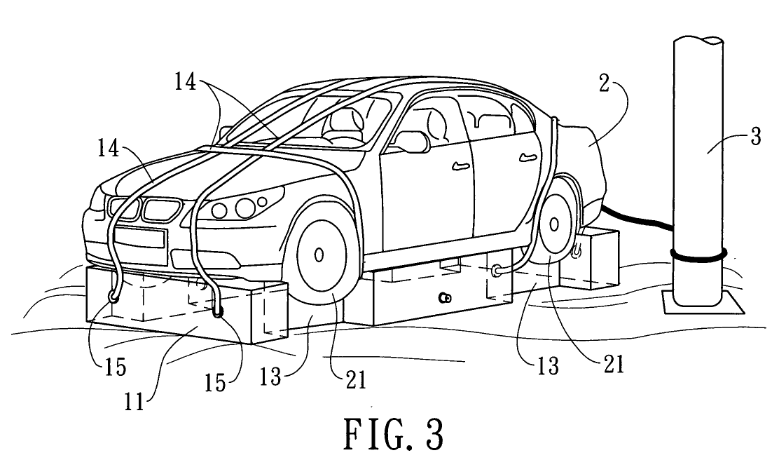

Referring to FIG. 1-3, an embodiment of an inflatable cushion structure according to the invention comprises a cushion body 11 that is provided with an air passage 12 for air to inflate or deflate the cushion body 11.

In this embodiment, two indents 13 are provided inwardly on two sides of said cushion body 11 and a plurality of holes 15 for binding ropes 14 are provided along the periphery of the cushion body 11. Thereby, when said cushion body 11 is placed beneath the chassis of a car 2 and is inflated, the inflated cushion body 11 can just lift the car 2 upwardly and apart from the ground, whereby wheels 21 of the car 2 can be just accommodated in each respective indent 13 on two sides of the cushion body 11, and while ropes 14 can securely bind said cushion body 11 with the chassis of the car 2 through the plurality of holes 15 on the surface of said cushion body 11. Moreover, the cushion body 11 is provided on its surface with a plurality of supporting ribs 16 for supporting the strength of said cushion body 11. Said supporting ribs 16 are provided in parallel over the surface of the cushion body 11.

In practice, referring to FIG. 1-3, the inflatable cushion structure 1 is placed first under the chassis of a car 2 in a manner that each indent 13 on two lateral sides of said cushion body 11 can accommodate a wheel 21 of the car 2, respectively. Then, each of ropes 14 is penetrated through a respective hole 15 provided over the surface along the periphery of the cushion body 11, and thereby securely binds the cushion body 11 with the car 2. With this invention, before a typhoon or heavy rain, the car owner can inflate the cushion body 11 by, for example, manual or electrical means or by means of the electric power from the car 2 to inflate the cushion body 11 via the air passage 12 on the cushion body 11. When the cushion body 11 is inflated, a plurality of supporting ribs 16 on the cushion body 11 can increase the strength of the cushion body 11. As the cushion body 11 is inflated, the car 2 will be lifted upwardly and apart from the ground by it. As the result, once water accumulated or flooded due to heavy rain, the risk of car immersing can be avoided or lowered.

In addition, in practicing the embodiment of the invention, the car 2 can be fixed together with a fastener 3 on the ground (for example, an electric cord pole, a house, and the like) so as to prevent the car 2 and the cushion body 11 from drifting randomly on the water after the cushion body 11 being inflated.

Accordingly, based on the above description and the accompanying drawings, the invention can achieve the intended objective by providing an inflatable cushion structure that can prevent a car from immersing in water. Many changes and modifications in the above-described embodiment of the invention can, of course, be carried out without departing from the scope thereof. Those equivalent changes and modifications are intended to be encompassed within the scope of the invention defined by the appended claims.

What is claimed is:

1. An inflatable cushion structure, comprising a cushion body that is provided with an air passage for air to inflate and deflate said cushion body, the improvement characterized in that:
indents are provided inwardly on lateral sides of said cushion body, while a plurality of holes are provided along the periphery of said cushion body for binding by ropes, such that, after placing said cushion body under a car and inflating said cushion body, the inflated cushion body can lift said car upwardly and apart from the ground, while each wheel of said car can be accommodated just in respective indent on lateral sides of said cushion body, and while ropes can penetrate through said plurality of holes on the surface of the cushion body and securely bind said cushion body with the chassis of the car.

2. An inflatable cushion structure as recited in claim 1, wherein the surface of said cushion body is provided further with a plurality of supporting ribs for supporting the strength of said cushion body.

3. An inflatable cushion structure as recited in claim 2, wherein said supporting ribs are provided in parallel over the surface of said cushion body.
